(19) United States
(12) Patent Application Publication
(10) Pub. No.: US 2018/0080258 A1
(43) Pub. Date: Mar. 22, 2018

(54) Mechanical Button Actuating Portable Suitcase Locking Device

(71) Applicant: Dongguan ChongWei Metals & Plastic Products Factory Co., Ltd., Dongguan (CN)

(72) Inventor: Mengxiao Yuan, Dongguan (CN)

(73) Assignee: Dongguan ChongWei Metals & Plastic Products Factory Co., Ltd.

(21) Appl. No.: 15/703,593

(22) Filed: Sep. 13, 2017

(30) Foreign Application Priority Data
Sep. 20, 2016 (CN) 201610833987.4

(51) Int. Cl. E05B 65/52; E05C 9/04; E05C 9/00; E05B 1/00

(52) U.S. Cl. CPC E05B 65/5238; E05C 9/047; E05B 1/0038; E05C 9/04; E05C 9/006

(57) ABSTRACT

A mechanical button actuating portable suitcase locking device includes a lock seat, two first openings formed on the lock seat for accommodating a lock hook of a suitcase cover, a second opening formed on the lock seat, a button device installed in the second opening, two latch mechanisms installed on both sides of the button device. The button device includes a button seat, a second button installed in the button seat, two first cams symmetrically installed in the button seat for receiving the actuation of the second button. The latch mechanism includes two sliding grooves symmetrically formed in the lock seat, two sliding plates installed on a side of the two first cams and slidable in the sliding grooves respectively, two catch members symmetrically installed onto the sliding plate and capable of hooking the lock hook, and a cylinder spring installed between the sliding plate and the catch member.

### FIELD OF INVENTION

The present invention relates to the field of locks, in particular to a mechanical button actuating portable suitcase locking device.

### BACKGROUND OF INVENTION

### 1. Description of the Related Art

Hard suitcases generally adopt a mechanical key to open a lock of the suitcase or adopt a combination lock. In the suitcases adopting the mechanical key to open the lock, the locking device, lock and key of the suitcases of this sort come with a simple structure, so that the lock can be opened by a similar key or tool. In the suitcases adapting the combination lock, the number of combinations is relatively small, and the unlock operation is relatively complicated.

A latching device for portable suitcase as disclosed in U.S. Pat. No. 3,961,505 filed by Presto Lock, Inc comprises two sets of combination locks installed symmetrically on the suitcase, and a knob installed on an outer side of the two sets of combination locks, and the knob may be turned to actuate a sliding plate for locking and unlocking. After a correct password is entered, the knob can be rotated to push the sliding plate to displace the lock hook and detect the locking.

As disclosed in P.R.C. Pat. No. CN95222733.9 issued to Taiwanese Hedbou Metal Industrial Co., Ltd, a suitcase lock comprises a lock seat, a pair of combination locks installed to the lock seat, and two sliding plates, and a catch member is coupled to the sliding plate, and the suitcase lock further comprises an elastic positioning plate compressed by the combination lock and then latched with the sliding plates, and two buttons installed on both sides of the pair of combination locks. If the password of the combination lock is correct, then the compressed positioning plate will be detached from the latch with the sliding plate, and then the right button is pressed, so that two sliding plates will be displaced towards both sides respectively, and the lock hook of the suitcase cover will be detached. To change to a new password, the left button is pressed and then the password changing operation is performed.

In the aforementioned technical solutions, most of the devices used for entering a password to unlock the suitcase are mechanical combination locks, and the combination lock is generally installed on the front vertical surface of the suitcase. In the first technical solution, two combination locks are installed, so that it is necessary to unlock both combination locks in order to unlock and open the suitcase. In the second technical solution, a set of r combination locks are installed, but two buttons are installed to overcome the problem of changing the password. After the password is entered, it is necessary to operate a mechanical button manually or rotate or press the mechanical button to actuate the lock mechanism in order to detach the hooking of the lock hook of the suitcase cover. The button is also installed adjacent to the combination lock (in other words, the button is installed on a side of the suitcase with the handle). The aforementioned conventional portable suitcase combination lock comes with a complicated structure, low safety and reliability, and inconvenient operation, and thus the suitcase applying the password control has a limited scope of applicability.

### 2. Summary of the Invention

Therefore, it is a primary objective of the present invention to provide a mechanical button actuating portable suitcase locking device installed onto a suitcase cover and controlled by an electronic password.

To achieve the aforementioned and other objectives, the present invention provides a mechanical button actuating portable suitcase locking device, comprising: a lock seat, a pair of first openings formed on the lock seat for accommodating the lock hook of a suitcase cover, characterized in that the mechanical button actuating portable suitcase locking device further comprises a second opening formed on the lock seat, a button device installed in the second opening, a pair of lock mechanisms installed on both sides of the button device respectively; the button device comprises: a button seat, a second button installed in the button seat, a pair of first cams symmetrically installed in the button seat for receiving the actuation of the second button; the lock mechanism comprises: a pair of sliding grooves symmetrically formed in the lock seat, a pair of sliding plates installed on a side of the pair of first cams and slidable in the sliding grooves respectively, a pair of catch members symmetrically installed onto the sliding plate and capable of hooking the lock hook, and a cylinder spring installed between the sliding plate and the catch member.

Wherein, the second button comprises: a horizontally installed pressure bearing block, a pair of vertical plates perpendicular to the pressure bearing block, a horizontal plate installed between the pair of vertical plates, and a pair of first guide grooves symmetrically formed on both front and rear sides of the pressure bearing block; the button seat comprises: a first frame embeddable into the second opening, a third opening formed in the first frame and matched with the outer contour of the pressure bearing block, a pair of first guide strips slidably matched with the first guide groove, a fourth opening formed at the bottom of the first guide strip and perpendicular to the third opening, and a pair of hinge cavities symmetrically formed on both sides of the first frame; the first cam comprises: a first flange disposed in the hinge cavity and hinged with a wall of the hinge cavity, a second flange abutting against the lower edge of the pressure bearing block, and a third flange abutting against an end of the sliding plate.

Wherein, the pressure bearing block includes three pressure bearing heads, and the middle one is the first pressure bearing head, and the second pressure bearing head is disposed on both outer sides of the first pressure bearing head, and the guide groove is formed on both sides of the first pressure bearing head, and the vertical plate is installed on an outer side of the guide groove, and the bottom of the vertical plate has a limit block, and the horizontal plate has an outer edge for stopping an end of the first guide strip; and the button seat comprises: a pair of first hinge holes formed on the hinge cavity, and a pair of lower edge formed a the fourth opening for hooking the limit block.

Wherein, the first cam is formed by connecting three cylindrical surfaces triangularly distributed with respect to a center, and the first flange is a first cylinder, and the second flange is a second cylinder disposed under the second pressure bearing head, and the third flange is a third cylinder disposed under the first cylinder and the second cylinder, and the first cylinder has a second hinge hole with a diameter equal to that of the first hinge hole and further includes a first hinge shaft matched with the first hinge hole and the second hinge hole.

The mechanical button actuating portable suitcase locking device further comprises a second guide strip installed at the front and rear end surfaces of the vertical plate, and the second guide strip and the front and rear surfaces of the button seat are slidably matched.

Wherein, the lock seat comprises: a top, a bottom, and a vertical plate, and the top and bottom have a sliding plate embedded therein and provided for sliding the sliding plate in the sliding groove; and the sliding plate comprises: a first rectangular hole embedded into the catch member and provided for sliding the catch member, a positioning strip installed in the first rectangular hole, a stop plate installed in the first rectangular hole, a push plate installed to an end of the sliding plate, and the push plate and the third cylinder abut against each other.

Wherein, the catch member comprises: a top, a bottom, a side, and two end surfaces, and a second rectangular hole formed at the top for accommodating, entering and retracting the lock hook, a rectangular protrusion formed on a side of the catch member and embeddable into the first rectangular hole, a first oblique surface disposed at an end of the catch member and a positioning post disposed at the other end of the catch member, and the cylinder spring is installed between the positioning post and the positioning strip.

The mechanical button actuating portable suitcase locking device further comprises a front cover plate installed onto the lock seat, a lock hole formed at the middle of the front cover plate, and a pair third rectangular holes symmetrically formed on both sides of the lock hole.

The mechanical button actuating portable suitcase locking device further comprises a hasp plate installable into the third rectangular hole, and the hasp plate comprising a first hook for hooking an edge of the first rectangular hole and a second hook for hooking an edge of the third rectangular hole, and the first hook further includes a first oblique surface of the catch member abutting against a second oblique surface.

The mechanical button actuating portable suitcase locking device further comprises a lock head installed onto the lock seat, and the lock head comprising a lock core rotatable by a matched key, a bias shaft installed to the rear end of the lock core and rotatable with the lock core to displace the second button downward.

The mechanical button actuating portable suitcase locking device further comprises a positioning plate installed to the front end of the lock head and a positioning groove for embedding the positioning plate, and the bias shaft being extended between a pair vertical plate of the second button and disposed on the horizontal plate.

The present invention has the following advantages and effects:

1. The present invention adopts the button for changing the pressure applied in the vertical direction in to a pushing force in the horizontal direction, so that the password control device can be installed onto the suitcase cover to facilitate applying the electronic combination lock to suitcase.

2. The present invention combines three cylinders to form the special first cam, not just providing a special button for converting the vertical pressure into the horizontal pushing force only, but also making the structure simple and the manufacture easy.

3. The present invention installs the lock in the button seat, not just satisfying the requirement for unlocking the lock in a special situation only, but also installing the lock and the button in the same button seat to save additional components.

4. Compared with the conventional suitcase lock, the present invention has the features of less components, compact structure, and reduced manufacturing time and material cost.

### BRIEF DESCRIPTION OF THE DRAWINGS

FIG. 1 is a perspective view of a preferred embodiment of the present invention;

FIG. 2 is an exploded view of a preferred embodiment of the present invention;

FIG. 3 is a perspective view of a second button of a preferred embodiment of the present invention;

FIG. 4 is another perspective view of a second button of a preferred embodiment of the present invention;

FIG. 5 is a perspective view of a button seat of a preferred embodiment of the present invention;

FIG. 6 is a perspective view of a first cam of a preferred embodiment of the present invention;

FIG. 7 is a perspective view of a sliding plate of a preferred embodiment of the present invention;

FIG. 8 is a perspective view of a catch member of a preferred embodiment of the present invention;

FIG. 9 is a perspective view of a hasp plate of a preferred embodiment of the present invention; and

FIG. 10 is a perspective view of a lock head of a preferred embodiment of the present invention.

### DESCRIPTION OF THE PREFERRED EMBODIMENTS

The above and other objects, features and advantages of this disclosure will become apparent from the following detailed description taken with the accompanying drawings.

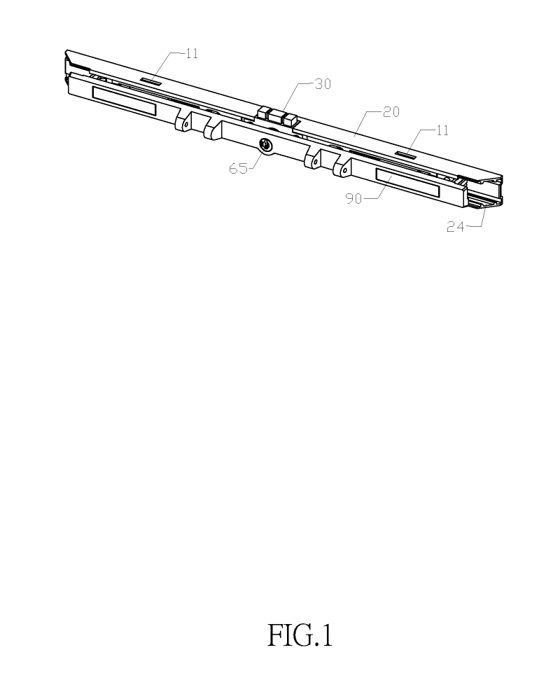

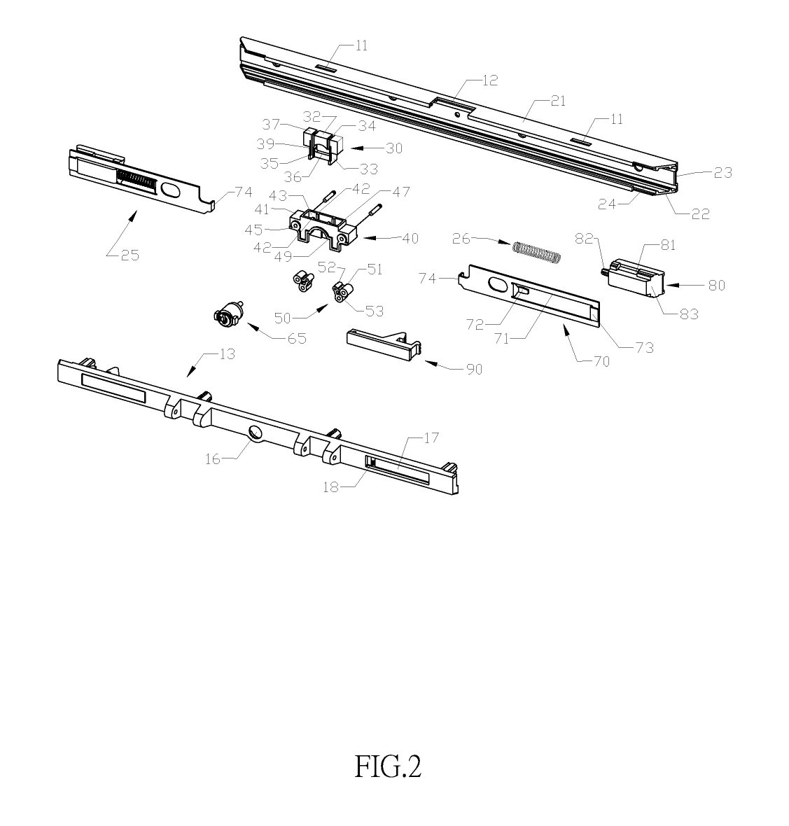

With reference to FIGS. 1 and 2 for the structure of a portable suitcase in accordance with a preferred embodiment of the present invention, the lock seat 20 is installed to a suitcase body, and the lock seat comprises a pair of first openings 11 for accommodating a lock hook formed on a suitcase cover. Unlike the conventional portable suitcase, the direction of the second opening 12 at the middle of the lock seat is the same as the direction of the first opening 11, and both face upward and towards the suitcase cover. When the suitcase cover is situated at the closed position, the second opening 12 is aligned precisely with a controlled first button (not shown in the figure) installed on the suitcase cover. The second opening 12 has a button device installed therein, and the button device comprises a button seat 40, a second button 30 and a pair of first cams 50. The first cams 50 are hinged to the first hinge shaft 46 in the hinge cavities 41 at both ends of the button seat 40. The top of the button seat 40 has a third opening 43 for accommodating the second button 30, and the third opening 43 is in a shape matched with the outer contour of the second button 30, and they have a corresponsive sliding relation with each other, and after the second button 30 is installed into the third opening 43, the second button 30 can be displaced up and down. A rectangular first frame 47 is protruded upwardly from an edge of the third opening 43 and precisely embedded into the second opening 12, and the outer top of the hinge cavity 41 on both sides precisely abuts against the lower edge of the second opening 12. After the button seat 40 is installed into the second opening 12, the rectangular first frame 47 is aligned precisely and evenly with the outer plane of the second opening 12.

In the structure of the lock seat 20 as shown FIGS. 1 and 2, the lock seat 20 is an open-slotted structure having a top 21, a bottom 22 and a backside 23, and the top 21 and the bottom 22 have a sliding groove 24 for receiving a sliding plate 70, and the distance between the top 21 and the bottom 22 fits the embedment of the button seat 40 precisely, and the front end surfaces of the two planes are aligned evenly with each other and can be attached onto the inner plane of the vertical surface of the suitcase body. The lock seat 20 and the suitcase body are fixed in a similar way as the conventional portable suitcase, and thus it will not be described here. The lock seat 20 may be made of metal such as aluminum alloy, or any other constructing material such as plastic, and this preferred embodiment adopts aluminum alloy as the material for making the lock seat 20.

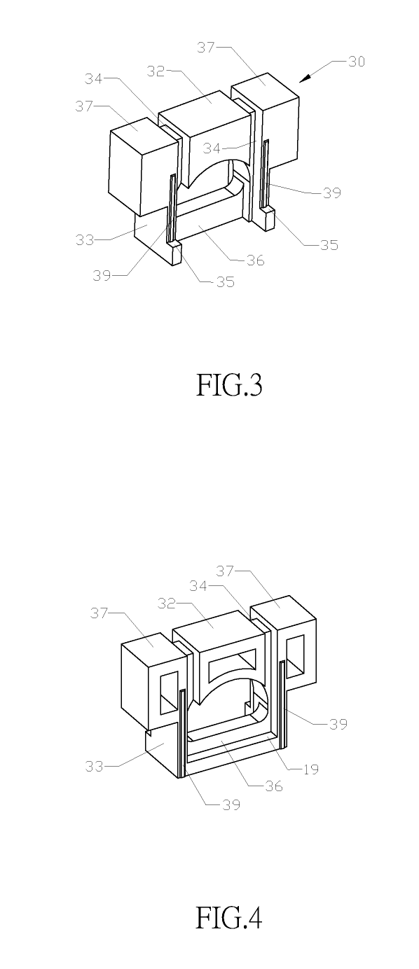

In the structure of the second button 30 as shown in FIGS. 3 and 4, the second button 30 comprises a horizontal rectangular pressure bearing block and two symmetrical vertical plates 33 extended vertically downward, and the pressure bearing block has three pressure bearing heads, and the second pressure bearing heads 37 on both sides of the pressure bearing block are slightly smaller than a first pressure bearing head 32 disposed at the middle. A pair of first guide grooves 34 divide and separate the three pressure bearing heads, and the first guide grooves 34 are extended from the front of the pressure bearing block to the top and then to the backside, and the two vertical plates 33 are symmetrically installed under the first guide grooves 34, and the two second pressure bearing heads 37 are protruded to the outside with respect to the vertical plate 33, and the second flange 52 of the first cam 50 is disposed precisely at the bottom of the second pressure bearing head 37. The two end surfaces at the front and rear of the vertical plate 33 have a second guide strip 39, and the second guide strip 39 on one of the surfaces is matched with the front inner surface of the button seat 40, and the second guide strip 39 on the other surface is matched with the rear inner surface of the button seat 40, so as to achieve the effect of increasing the limit surface of the button seat 40 and the second button 30, so that the second button 30 can be displaced vertically up and down in the button seat 40 more stably. At the lower end of the vertical plate 33, a rectangular limit block 35 of a protrusion is extended to the front, and when the limit block 35 at the second button 30 is situated at the initial position (while the second button 30 is not pressed) and precisely hooked with a lower edge 49 of the fourth opening 44 of the button seat 40 to limit the upward displacement of the second button 30. The lower end portion of the two vertical plates has a horizontal plate 36, and the bottom of the horizontal plate 36 has an outer edge 19 which forms the lower end portion of the first guide groove 34, and its extending direction is opposite to the limit block 35 and its effect is the same as the limit block 35, and both of them are disposed at different front and rear sides of the second button 31 respectively. When the second button 30 is situated at its initial position (when the second button 30 is not pressed), the outer edge 19 precisely abuts the lower end surface of the first guide strip 42 to limit the second button 31. After the lock 65 is installed, the bias shaft 69 installed at the rear end of the lock 65 is precisely disposed on the horizontal plate 36. When a lock cylinder 67 is rotated with a key, the bias shaft 69 will pull the second button 30 to displace downward, so as to rotate the first cam 50 and push the latch mechanism 25 to detach from the hooking of the lock hook. The latch mechanism comprises: a pair sliding grooves of symmetrically installed in the lock seat 20, a pair of sliding plates 70 installed on a side of the pair first cam 50 and slidable in the sliding groove, a pair of catch members symmetrically installed on the sliding plate and hooked to the lock hook, and a cylinder spring 26 installed between the sliding plate 70 and the catch member 80.

With reference to FIG. 5 for the structure of a button seat 40 of the invention, the button seat 40 is a hollow casing, and the third opening 43 at the top is in a shape matched with the shape of the pressure bearing block, which is in a rectangular shape, and the hinge cavity 41 of the lock seat 40 has a first hinge hole 45 formed thereon, and the first flange 51 of the cam 50 has a first hinge hole 45 formed thereon and having a diameter equal to the diameter of the second hinge hole 54, and the first hinge shaft 46 is passed through the first hinge hole 45 and the second hinge hole 54 to connect the cam 50 and the button seat 40 together. The front and rear inner planes of the button seat 40 have two first guide strip 42 slidably configured to be corresponsive to the first guide grooves 34 respectively, and a front plate of the button seat 40 has a fourth opening 44 formed thereon, and the fourth opening 44 has a circular arc top 48 and is provided for accommodating the lock cylinder 67 of the lock 65, and the rear plate of the button seat 40 has a fixing hole 56 for fixing the button seat 40 onto the lock seat 20.

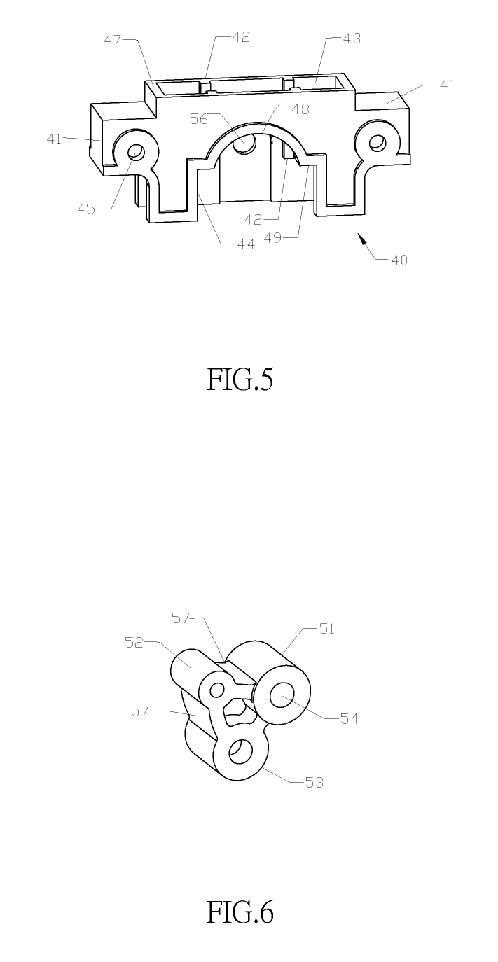

With reference to FIG. 6 for the structure of a first cam 50 of the invention, the first cam is formed by connecting three cylindrical surfaces with their center distributed in a triangular shape. Specifically, the first cam 50 is formed by connecting three cylinders which are parallel to three axes respectively, and the center of the three cylinders are distributed in a triangular shape, and the first cylinder having a second hinge hole 54 is a first flange 51, and the second cylinder disposed under the second pressure bearing head 37 (which is disposed on the inner side of the first cylinder as shown in the figure) is a second flange 52, and the third cylinder disposed under the first cylinder and the second cylinder and abutted at a push plate 74 at an end of the sliding plate 70 is a third flange 53. Obviously, the three cylinders are not intersected with one another, and they are connected together by three arc plates 57. The cam 50 is a whole piece made of metal or plastic. In FIG. 2, after the first cam 50 is installed into the button seat 40, the first cam 50 can rotate within a range of 90 degrees around the first hinge shaft 46. After the second flange 52 is pushed by the downward force of the pressure bearing block, the third flange 53 starts pushing the sliding plate 70 to move towards the outside, so that the vertically downward displacement of the second button 30 is converted into the horizontally outward displacement of the sliding plate 70.

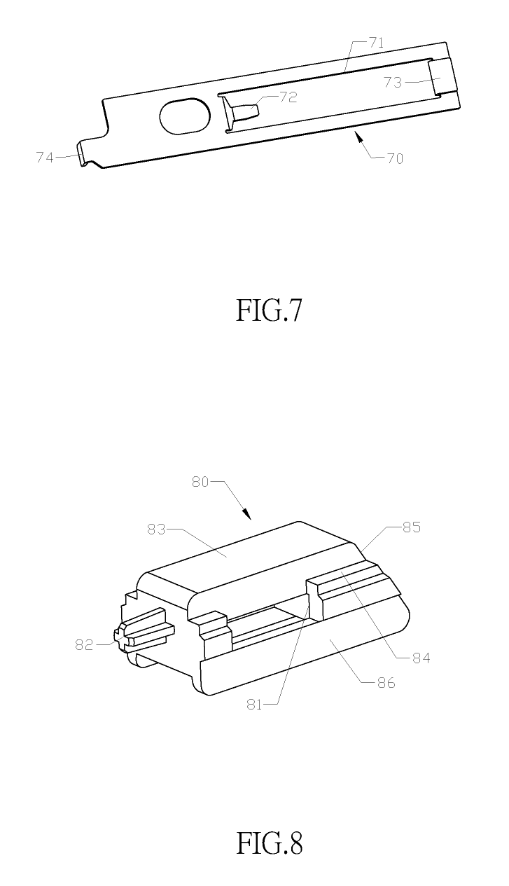

With reference to FIG. 7 for the structure of a sliding plate 70 of the invention, the sliding plate 70 is substantially a rectangular plate, and the sliding plate 70 has a first rectangular hole 71, and the catch member 80 can be partially embedded into the first rectangular hole 71 and slidable in the hole. An end proximate to the first cam 50 has a positioning strip 72 extended toward the other end and entered into the inner periphery of the cylinder spring 26, and the other end of the first rectangular hole 71 has a stop plate 73 parallel to a plane of the sliding plate 70, and the stop plate 73 is formed by bending a convex strip at an edge of the first rectangular hole 71 for 180 degrees. After the stop plate 73 is displaced outwardly from the sliding plate 70 to a position abutting the hasp plate 90, a limit effect is achieved. The plane of the push plate 74 is perpendicular to the plane of the sliding plate 73, and it has a circular arc surface matched with the third cylinder. After the first cam 50 and the sliding plate 70 are installed, the push plate 74 under the effect of bias force of the cylinder spring 26 abuts at the third flange 53 precisely, and after the bias force of the cylinder spring 26 is transmitted through the first cam 50, the top of the second pressure bearing head 37 of the second button 31 abuts at the lower edge of the third opening 43 of the button seat 40. In the meantime, the catch member 80 maintains a preset force to hook the lock hook in an outward direction.

With reference to FIG. 8 for the structure of a catch member 80 of the invention, the catch member 80 is a hollow rectangular member including a top 86 a bottom, two end surfaces, and a side. A second rectangular hole 81 is formed between the top 86 and the side for accommodating entering and retracting the lock hook, and an outwardly extended hook portion of the lock hook can be hooked to an edge of the second rectangular hole 81. A protrusion formed on a side of the catch member 80 has a rectangular protrusion 83 with a width precisely embeddable into in the first rectangular hole 71, and the rectangular protrusion 83 has a guide rail 84 slidably configured to be corresponsive to both upper and lower edges of the two opposite concave first rectangular holes 71 respectively. An end surface of the catch member 80 has a positioning post 82, and the positioning post 82 and the positioning strip 72 on the sliding plate 70 are coaxially configured with each other, and the cylinder spring 26 is limited between the positioning post 82 and the positioning strip 72. The other end surface of the catch member 80 is a first oblique surface 85, and the first oblique surface 85 is matched with a second oblique surface 94 of the hasp plate 90. In this preferred embodiment, the top and bottom of the catch member 80 are configured symmetrically with respect to each other.

With reference to FIG. 9 for the structure of a hasp plate 90 of the invention, the hasp plate 90 is a rectangular member, and the front cover plate 13 has a pair of symmetrical third rectangular holes 17 for accommodating the hasp plate 90, and an end of the inner side of the rectangular hole has a second hinge shaft 18, and an end of the hasp plate 90 has a second hinge hole 98 configured to be corresponsive to the second hinge shaft 18, and the backside of the second oblique surface 94 has a second hook 92 capable of hooking to the lower edge of the first rectangular hole 17, and the backside of the second oblique surface 94 has a first hook 91 capable of hooking to the lower edge of an end of the third rectangular hole 71.

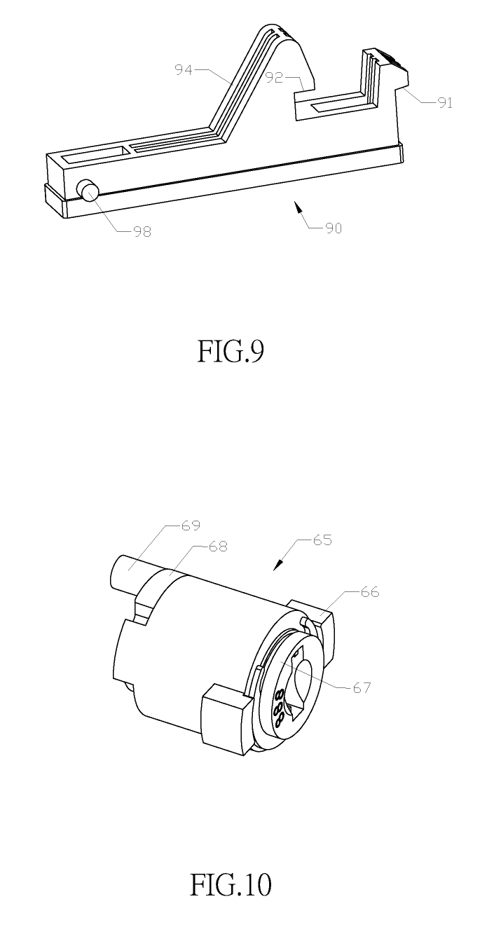

With reference to FIG. 10 for the structure of a lock 65 of the invention, the lock 65 is installed at the middle of the lock seat, and the lock 65 comprises a pair of radially protruded positioning plates 66, a lock cylinder 67, and a second cam 68 installed at the rear of the lock cylinder 67, and the middle of the front cover plate 13 has a lock hole 16 for exposing the lock 65 and a positioning groove formed on both sides of the lock hole 16 separately and configured to be corresponsive to the positioning plate 67, and the second cam 68 and the lock cylinder 67 are configured coaxially with respect to each other, and a bias shaft 69 is included, so that when the lock 65 is situated at a locked position, the bias shaft 69 is disposed on the horizontal plate 36 of the second button 31. When the lock cylinder 67 is rotated to an angle by a key, the bias shaft 69 presses the second button 30 to displace downward to push the first cam 50 to rotate and displace the sliding plate 70 sideway, so as to detach the catch member 80 from the hooking of the lock hook.

It is noteworthy that the purpose of installing the lock 65 is to facilitate users to unlock the key in order to open the suitcase in a special situation. The so-called situation refers to a situation when a user forgets the unlock password, the panel device breaks down, or the battery has a very low level of power and affects normal operations. The lock further provides an option for users, and such lock may be replaced by a TSA lock.

The locking and unlocking procedure of this preferred embodiment of the invention are described below:

When it is necessary to unlock the suitcase, the user enters a predetermined unlock password through an electronic input device installed on the suitcase cover. After the inputted password is determined to be correct, an electrical mechanism releases the locking with respect to the first button. Now, the user presses the first button, and the second button 30 is displaced downward by the pushing force to push the first cam 50 to rotate in a forward direction, and the first cam 50 also pushes the sliding plate 70 to displace toward the outside. After the cylinder spring 26 is pushed by the sliding plate 70, the catch member 80 is pushed to displace towards the outside until the lock hook is detached form the hooked position. Now, the catch member 80 props the hasp plate 90 and rotates to an angle and out from the rectangular hole 17 of the front cover plate 13, so as to complete the locking procedure, and then the suitcase cover 60 can be opened manually. After the external force exerted onto the first button is released, the first button is reset to resume the sleep/standby state after the electrical mechanism locks the first button.

When it is necessary to lock the suitcase, the suitcase cover is covered, and then the hasp plate 90 is pushed into the rectangular hole 17, and the catch member 80 is displaced towards the inside by the pushing force of the hasp plate 90. After the cylinder spring 70 is compressed, the sliding plate 70 is displaced towards the inside, and the first cam 50 is rotated in the opposite direction by the pushing force of the sliding plate 70, and the second button 30 is pushed upward and reset. Now, the catch member 80 returns to its latching position with respect to the lock hook 61, and the suitcase enters into the locked state.

While the invention has been described by means of specific embodiments, numerous modifications and variations could be made thereto by those skilled in the art without departing from the scope and spirit of the invention set forth in the claims.

What is claimed is:

1. A mechanical button actuating portable suitcase locking device, comprising: a lock seat, a pair of first openings formed on the lock seat for accommodating the lock hook of a suitcase cover, characterized in that the mechanical button actuating portable suitcase locking device further comprises a second opening formed on the lock seat, a button device installed in the second opening, a pair of lock mechanisms installed on both sides of the button device respectively; the button device comprises: a button seat, a second button installed in the button seat, a pair of first cams symmetrically installed in the button seat for receiving the actuation of the second button; the lock mechanism comprises: a pair of sliding grooves symmetrically formed in the lock seat, a pair of sliding plates installed on a side of the pair of first cams and slidable in the sliding grooves respectively, a pair of catch members symmetrically installed onto the sliding plate and capable of hooking the lock hook, and a cylinder spring installed between the sliding plate and the catch member.

2. The mechanical button actuating portable suitcase locking device according to claim 1, wherein the second button comprises: a horizontally installed pressure bearing block, a pair of vertical plates perpendicular to the pressure bearing block, a horizontal plate installed between the pair of vertical plates, and a pair of first guide grooves symmetrically formed on both front and rear sides of the pressure bearing block; the button seat comprises: a first frame embeddable into the second opening, a third opening formed in the first frame and matched with the outer contour of the pressure bearing block, a pair of first guide strips slidably matched with the first guide groove, a fourth opening formed at the bottom of the first guide strip and perpendicular to the third opening, and a pair of hinge cavities symmetrically formed on both sides of the first frame; the first cam comprises: a first flange disposed in the hinge cavity and hinged with a wall of the hinge cavity, a second flange abutting against the lower edge of the pressure bearing block, and a third flange abutting against an end of the sliding plate.

3. The mechanical button actuating portable suitcase locking device according to claim 2, wherein the pressure bearing block includes three pressure bearing heads, and the middle one is the first pressure bearing head, and the second pressure bearing head is disposed on both outer sides of the first pressure bearing head, and the guide groove is formed on both sides of the first pressure bearing head, and the vertical plate is installed on an outer side of the guide groove, and the bottom of the vertical plate has a limit block, and the horizontal plate has an outer edge for stopping an end of the first guide strip; and the button seat comprises: a pair of first hinge holes formed on the hinge cavity, and a pair of lower edge formed at the fourth opening for hooking the limit block.

4. The mechanical button actuating portable suitcase locking device according to claim 3, wherein the first cam is formed by connecting three cylindrical surfaces triangularly distributed with respect to a center, and the first flange is a first cylinder, and the second flange is a second cylinder disposed under the second pressure bearing head, and the third flange is a third cylinder disposed under the first cylinder and the second cylinder, and the first cylinder has a second hinge hole with a diameter equal to that of the first hinge hole and further includes a first hinge shaft matched with the first hinge hole and the second hinge hole.

5. The mechanical button actuating portable suitcase locking device according to claim 4, further comprising a second guide strip installed at the front and rear end surfaces of the vertical plate, and the second guide strip and the front and rear surfaces of the button seat are slidably matched.

6. The mechanical button actuating portable suitcase locking device according to claim 4, wherein the lock seat comprises: a top, a bottom, and a vertical plate, and the top and bottom have a sliding plate embedded therein and provided for sliding the sliding plate in the sliding groove; and the sliding plate comprises: a first rectangular hole embedded into the catch member and provided for sliding the catch member, a positioning strip installed in the first rectangular hole, a stop plate installed in the first rectangular hole, a push plate installed to an end of the sliding plate, and the push plate and the third cylinder abut against each other.

7. The mechanical button actuating portable suitcase locking device according to claim 6, wherein the catch member comprises: a top, a bottom, a side, and two end surfaces, and a second rectangular hole formed at the top for accommodating, entering and retracting the lock hook, a rectangular protrusion formed on a side of the catch member and embeddable into the first rectangular hole, a first oblique surface disposed at an end of the catch member and a positioning post disposed at the other end of the catch member, and the cylinder spring is installed between the positioning post and the positioning strip.

8. The mechanical button actuating portable suitcase locking device according to claim 1, further comprising a front cover plate installed onto the lock seat, a lock hole formed at the middle of the front cover plate, and a pair third rectangular holes symmetrically formed on both sides of the lock hole.

9. The mechanical button actuating portable suitcase locking device according to claim 8, further comprising a hasp plate installable into the third rectangular hole, and the hasp plate comprising a first hook for hooking an edge of the first rectangular hole and a second hook for hooking an edge of the third rectangular hole, and the first hook further includes a second oblique surface abutting against the first oblique surface of the catch member.

10. The mechanical button actuating portable suitcase locking device according to claim 1, further comprising a lock installed onto the lock seat, and the lock comprising a lock cylinder rotatable by a matched key, a bias shaft installed to the rear end of the lock cylinder and rotatable with the lock cylinder to displace the second button downward.

11. The mechanical button actuating portable suitcase locking device according to claim 10, further comprising a positioning plate installed to the front end of the lock and a positioning groove for embedding the positioning plate, and the bias shaft being extended between a pair vertical plate of the second button and disposed on the horizontal plate.
